(19) United States
(12) Patent Application Publication
(10) Pub. No.: US 2005/0169230 A1
(43) Pub. Date: Aug. 4, 2005

(54) Radio-controlled clock, receiver circuit and method for acquiring time information with economized receiver and microcontroller

(75) Inventor: Horst Haefner, Heilbronn (DE)

Correspondence Address: FASSE PATENT ATTORNEYS, P.A., P.O. BOX 726, HAMPDEN, ME, 04444-0726, US

(73) Assignee: ATMEL Germany GmbH, Heilbronn (DE)

(21) Appl. No.: 11/051,071

(22) Filed: Feb. 4, 2005

(30) Foreign Application Priority Data
Feb. 4, 2004 (DE) 10 2004 005 340.5

(51) Int. Cl. H04J 3/00

(52) U.S. Cl. 370/345

(57) ABSTRACT

A transmitted time signal carries time information encoded bit-wise by signal amplitude variations in a succession of time frames. A method involves receiving and evaluating the time signal in a receiver to acquire the time information, and then outputting from the receiver an individual data bit respectively allocated to a respective time frame during or at the end of or immediately after the respective time frame. It is not necessary to store all the data bits of a complete minute telegram in the receiver before the evaluation. The successive data bits are used by a microprocessor downstream from the receiver to produce a time signal. A circuit arrangement for a radio-controlled clock includes a receiving antenna connected to a receiver circuit that incorporates a time information decoder for decoding the time information contained in the time signal. The decoder provides, at an output of the receiver circuit, the decoded data bit allocated to a time frame, already during, at the end of, or immediately after the end of that time frame.

### CROSS-REFERENCE TO RELATED APPLICATION

This application is related to U.S. application Ser. No. 10/910,261, filed on Aug. 2, 2004, the entire disclosure of which is incorporated herein by reference.

### PRIORITY CLAIM

This application is based on and claims the priority under 35 U.S.C. §119 of German Patent Application 10 2004 005 340.5, filed on Feb. 4, 2004, the entire disclosure of which is incorporated herein by reference.

### FIELD OF THE INVENTION

The invention relates to a method for acquiring time information from a received amplitude-modulated time signal. The invention further relates to a radio-controlled clock and a receiver circuit for a radio-controlled clock, especially for carrying out such a method.

### BACKGROUND INFORMATION

It is conventionally known to provide time reference information in time signals that are transmitted by radio transmission from a time signal transmitter. Such a signal may also be called a time marker signal, a time data signal, a time code signal, or a time reference signal, for example, but will simply be called a time signal herein for simplicity. The time signal transmitter obtains the time reference information, for example, from a high precision atomic clock, and broadcasts this highly precise time reference information via the time signal. Thus, any radio-controlled clock receiving the signal can be synchronized or corrected to display the precise time in conformance with the time standard established by the atomic clock that provides the time reference information for the time signal transmitter. The time signal is especially a transmitter signal of short duration, that serves to transmit or broadcast the time reference information provided by the atomic clock or other suitable time reference emitter. In this regard, the time signal is a modulated oscillation generally including plural successive time markers, which each simply represent a pulse when demodulated, whereby these successive time markers represent or reproduce the transmitted time reference with a given uncertainty.

A time signal transmitter as mentioned above is, for example, represented by the official German longwave transmitting station DCF-77, which continuously transmits amplitude-modulated longwave time signals controlled by atomic clocks to provide the official atomic time scale for Central European Time (CET), with a transmitting power of 50 kW at a frequency of 77.5 kHz. In other countries, such as Great Britain, Japan, China, and the United States, for example, similar transmitters transmit time information on carrier waves in a longwave frequency range from 40 kHz to 120 kHz. In all of the above mentioned countries, the time information is transmitted in the time signal by means of a succession of time frames organized in time code telegrams that each have a duration of exactly one minute.

FIG. 1 diagrammatically represents the coding scheme of a time code or time information telegram A that pertains for the encoded time information provided by the German time signal transmitter DCF-77. The coding scheme or telegram in this case consists of 59 bits in 59 time frames, whereby each single bit or time frame corresponds to one second. Thus, the so-called time code telegram A, which especially provides information regarding the correct time and date in binary encoded form, can be transmitted in the course of one minute. The first 15 bits in bit range B comprise a general encoding, which contain operating information, for example. The next 5 bits in bit range C contain general information. Particularly, the general information bits C include an antenna bit R, an announcement bit A1 announcing or indicating the transition from Central European Time (CET) to Central European Summer Time (CEST) and back again, zone time bits Z1 and Z2, an announcement bit A2 announcing or indicating a so-called leap second, and a start bit S of the encoded time information.

From the 21^{st} bit to the 59^{th} bit, the time and date informations are transmitted in a Binary Coded Decimal (BCD) code, whereby the respective data are pertinent for the next subsequent or following minute. In this regard, the bits in the range D contain information regarding the minute, the bits in the range E contain information regarding the hour, the bits in the range F contain information regarding the calendar day or date, the bits in the range G contain information regarding the day of the week, the bits in the range H contain information regarding the calendar month, and the bits in the range I contain information regarding the calendar year. These informations are present bit-by-bit in encoded form. Furthermore, so-called test or check bits P1, P2, P3 are additionally provided respectively at the ends of the bit ranges D, E and I. The 60^{th} bit or time frame of the time code telegram A is not occupied, i.e. is “blank” and serves to indicate the beginning of the next telegram A. Namely, the minute marker M following the blank interval represents the beginning of the next time code telegram A.

The structure and the bit occupancy of the encoding scheme or telegram A shown in FIG. 1 for the transmission of time signals is generally known, and is described, for example, in an article by Peter Hetzel entitled “Zeitinformation und Normalfrequenz” (“Time Information and Normal Frequency”), published in Telekom Praxis, Vol. 1, 1993.

The transmission of the time marker or code information is performed by amplitude modulating a carrier frequency with the individual second markers. More particularly, the modulation comprises a dip or lowering or reduction X1, X2 (or alternatively an increase or raising) of the carrier signal X at the beginning of each second, except for the 59^{th} second of each minute, when the signal is omitted or blank as mentioned above. In this regard, in the case of the time signal transmitted by the German transmitter DCF-77, the carrier amplitude of the signal is reduced, to about 25% of the normal amplitude, at the beginning of each second for a duration X1 of 0.1 seconds or for a duration X2 of 0.2 seconds, for example as shown in present FIG. 2.

These amplitude reductions or dips X1, X2 of differing duration respectively define second markers or data bits in decoded form. The differing time durations of the second markers serve for the binary encoding of the time of day and the date, whereby the second markers X1 with a duration of 0.1 seconds correspond to the binary “0” and the second markers X2 with the duration of 0.2 seconds correspond to the binary “1”. Thus the modulation represents a binary pulse duration modulation. As mentioned above, the absence of the 60^{th} second marker announces the next following minute marker.

Thus, in combination with the respective second, it is then possible to evaluate the time information transmitted by the time signal transmitter. FIG. 2 shows a portion of an example of such an amplitude modulated time signal as discussed above, in which the encoding is achieved by respective temporary reductions or dips of the amplitude having different pulse durations. Note that the total duration of each time frame from the beginning of one dip to the beginning of the next dip or second marker X1 or X2 amounts to 1000 msec or 1 second, while the individual dips or amplitude reductions acting as second markers X1 and X2 respectively have individual durations of 100 msec or 200 msec, i.e. 0.1 seconds or 0.2 seconds, as described above for the German transmitter DCF-77. This evaluation of the exact time and the exact date is, however, only possible if the fifty-nine second bits of a minute are unambiguously recognized, and thus correspondingly, it is possible to unambiguously allocate either a “0” or a “1” to each of the second markers represented by the second bits of the signal.

The general technical background of radio-controlled clocks and receiver circuits for receiving time signals as generally discussed above are disclosed in the German Patent Publications DE 198 08 431 A1, DE 43 19 946 A1, DE 43 04 321 C2, DE 42 37 112 A1, and DE 42 33 126 A1. Furthermore, the methods and techniques for acquiring and processing the time information from transmitted time signals are disclosed in Patent Publications DE 195 14 031 C2, DE 37 33 965 C2, and EP 0,042,913 B1.

Conventional time signal receivers for radio-controlled clocks, for example as disclosed in the German Patent DE 35 16 810 C2, receive an amplitude-modulated time signal that has been radiated or transmitted by a time signal transmitter. The received time signal is demodulated by the receiver, which then correspondingly outputs a signal consisting of demodulated pulses having differing durations. These pulses are the so-called second pulses or second markers. This occurs in real time, that is to say a second pulse having a respective differing length or duration is produced and provided at the output of the receiver per second and thus per time frame of the received time signal (see FIG. 2).

This demodulated time signal consisting of the second pulses as mentioned above is provided from the receiver to a downstream-connected microcontroller, which evaluates the second pulses so as to thereby decode the time information contained in the demodulated time signal. In this evaluation process, a respective data bit is determined and allocated respectively to each second pulse by the microcontroller. In that regard, the microcontroller stores, in succession, all of the data bits of a corresponding minute of the time signal in an intermediate memory or storage arrangement specifically provided for this purpose in the microcontroller. Once all of the data bits corresponding to one complete minute telegram of the transmitted time signal are available, i.e. stored in the memory in the microcontroller, then the microcontroller will read-out these intermediately stored data bits, and will calculate the correct clock time and the correct date, i.e. the time and date information, from all of the data bits of the complete minute telegram.

As explained above, a microcontroller is used in the radio-controlled clock for decoding the time information of the time signal. For reasons of cost, the microcontroller, which is connected downstream to an output of the receiver as mentioned above, is typically embodied as a rather “small” four-bit microcontroller having a very small memory of approximately 2 Kbytes. Most of the storage capacity of this memory is taken up for the intermediate storage of the decoded data bits and for the storage of the program of the microcontroller, which predominantly serves for handling interference and various different second pulses. Thus, in present-day conventional radio-controlled clock applications, the available resources of the microcontroller are almost fully utilized simply for decoding the received second pulses and, if necessary, for handling any interference that may be superimposed on the time signal. Thus, the computational resources of the microcontroller, which are quite limited already from the beginning, are generally not available or only available in a very limited degree for other tasks.

For the above reasons, there is a trend in the development of future radio-controlled clocks, to attempt to reduce the computational effort to be handled by the microcontroller. This can be achieved in that the evaluation of the time signal for decoding the time information is no longer carried out by the microcontroller itself, but rather by the time signal receiver arranged upstream from the microcontroller. For example, such a time signal receiver and a corresponding radio-controlled clock equipped with such a time signal receiver are disclosed in the above referenced related U.S. application Ser. No. 10/910,261 filed on Aug. 2, 2004, the entire disclosure of which is incorporated herein by reference, and the corresponding German Patent Application 103 34 990.1. Thus, according to the related US Application, the time signal receiver comprises or incorporates its own decoder or time information acquisition arrangement that is adapted to acquire or extract the bit-wise time information contained in the demodulated time signal. The decoder or time information acquisition arrangement decodes the various different second pulses and determines and allocates a respective corresponding data bit to each respective second pulse. The individual data bits are then intermediately stored in a memory specifically provided for this purpose in the receiver. Once all of the data bits of a respective minute telegram of the received time signal are present in the memory in the receiver, then all of these data bits are read-out of the memory and transferred to the microcontroller. Then, in the microcontroller, these data bits are again intermediately stored. In order to calculate the exact clock time and the exact date, the data bits that are now stored in the memory in the microcontroller are once again read-out as needed to carry out the time information calculation.

Such a receiver circuit, however, requires a relatively large memory for storing all of the fifty-nine or sixty data bits of a complete minute telegram of the time signal. As a result, the time signal receiver, which is embodied as an integrated circuit, becomes relatively complicated and costly in terms of the circuit technology, circuit size, etc.

Furthermore, it is problematic that there is a relatively long reaction time between switching-on the radio-controlled clock and the first reaction of the time signal receiver to the time information received in the time signal. This arises because the decoded data bits corresponding to the time information of the time signal will first be transferred or provided to the microcontroller, at the earliest, after the end of a complete minute telegram of the time signal.

### SUMMARY OF THE INVENTION

In view of the above, it is an object of the invention to provide a receiver circuit that is economized and simplified with regard to its circuit technology, as well as a method for operating such a receiver circuit, that optimally unburden the microcontroller and provide time information more quickly. The invention further aims to avoid or overcome the disadvantages of the prior art, and to achieve additional advantages, as apparent from the present specification. The attainment of these objects is, however, not a required limitation of the claimed invention.

The above objects have been achieved according to the invention in a method of processing a transmitted time signal, comprising the steps:
a) receiving, with a receiver, an amplitude-modulated time signal that has been transmitted from a time signal transmitter, wherein the time signal comprises a succession of time frames and encodes time information bit-wise in successive data bits, with at least a respective one of the data bits allocated to each respective one of the time frames;
b) in the receiver, evaluating the time signal or a related signal derived therefrom to acquire the time information for a respective selected time frame among the time frames;
c) in the receiver, based on the evaluating, producing a respective individual data bit dependent on the time information and allocated to the selected time frame; and
d) outputting, from an output of the receiver, the individual data bit allocated to the selected time frame, during or at an end of or directly after the end of the selected time frame of the time signal being received in the step a).

The above objects have further been achieved according to the invention in a circuit arrangement for receiving and acquiring time information from a time signal that is transmitted by a time signal transmitter and that has the time information encoded in successive data bits in successive time frames therein, the circuit arrangement comprising:
a receiving antenna adapted to receive the time signal; and
a receiver circuit connected to the receiving antenna and adapted to process the time signal;
wherein the receiver circuit comprises:
a time information acquisition arrangement adapted to process the time signal so as to acquire the time information therefrom; and
a bit output arrangement that is included in or separate from the time information acquisition arrangement, and that is adapted to decode and produce a respective individual data bit corresponding to the time information and allocated to a selected time frame among the time frames, and that is adapted to output the respective individual data bit from an output of the receiver circuit during, at an end of, or directly after the end of the selected time frame.

Still further, the above objects have also been achieved according to the invention in a radio-controlled clock including the special circuit arrangement according to the invention and further comprising:
a memory that is separate from the receiver circuit, connected to the output of the receiver circuit, and adapted to sequentially store the individual data bits,
a program-controlled arrangement that is separate from the receiver circuit, may include or not include the memory, and is adapted to read-out the individual data bits from the memory and produce a time information signal in response to and dependent on the data bits; and
a local electronic clock connected to the program-controlled arrangement to receive the time information signal and adapted to indicate a time and/or date in response to and dependent on the time information signal.

The present invention is based on the general underlying recognition, that if the receiver itself is used for evaluating the received time signal to decode the time information contained therein, then it is not absolutely necessary for the data bits acquired as a result of this evaluation to be intermediately stored and only transferred to a downstream-connected microprocessor after all of the data bits corresponding to a respective complete minute telegram of the time signal have been acquired and accumulated. To the contrary, according to the invention, as soon as a respective data bit has been determined through the evaluation of the time signal carried out in the receiver, and allocated to a respective time frame of the time signal, then this individual data bit can be output by the receiver directly after it has been decoded and acquired. In this regard, the individual data bits either may be directly provided to the downstream-connected microprocessor, or alternatively may be intermediately stored in a buffer memory.

Namely, according to the invention, the time information contained in a respective time frame of the received time signal is evaluated to decode the time information and produce a respective corresponding data bit already during or at the end or directly after the end of the respective individual time frame to which the data bit is allocated, and this data bit may then immediately be automatically transmitted from the receiver to the microprocessor or its memory arrangement, still during or at the end or directly after the end of the respective time frame to which the data bit is allocated. Since the microprocessor according to conventional teachings would necessarily include a memory for storing all of the data bits of a complete minute telegram (e.g. fifty-nine or sixty data bits of fifty-nine or sixty corresponding time frames), the invention does not require any additional memory or any special or additional circuit arrangements in the microprocessor. Moreover, the memory otherwise needed in the receiver can be substantially reduced or even completely eliminated for the receiver according to the invention.

Thus, a special advantage of the present invention is that the individual data bits acquired through the evaluation or decoding carried out in the receiver no longer need to be stored in a suitably provided memory in the receiver circuit. For this reason, the circuit effort and expenditure for the receiver circuit are significantly reduced. The chip surface area of the receiver circuit can be correspondingly reduced, whereby the receiver circuit and thus the entire radio-controlled clock including such a receiver circuit can be produced more economically. Thus, in competition among circuit components and finished products that have essentially the same functions, as is the case in the field of radio-controlled clocks, it is a great competitive advantage to produce the circuit components and the radio-controlled clocks with reduced effort and at lower cost.

A further advantage of the invention is that the number of the required external connection terminals or pins of the receiver can be reduced. Particularly, the receiver circuit according to the invention (in comparison to conventional receiver circuits) no longer needs a pin for receiving a request for data (i.e. a data request pin), as well as a pin for signaling that valid data are available in the memory (i.e. a data ready pin). Moreover, the system clocking signal or timing pulse signal of the microprocessor can simply be directly used as a read-out timing pulse for reading-out the acquired data bits.

It is further especially advantageous according to the invention, that the reaction time of the radio-controlled clock and especially the receiver thereof is significantly reduced, because the decoded data bits are continuously output in succession by the receiver circuit during, or at the end of, or immediately following the end of each time frame, rather than waiting until all of the data bits of a respective complete minute telegram of the received time signal have been decoded and are available in an intermediate memory.

In a first alternative embodiment of the inventive method, the determination and outputting or transmission of a respective individual data bit is carried out still within or during the receiving of the time frame to which this respective data bit is allocated. This is possible because the pertinent time information is typically contained at the beginning of a time frame and does not take up the entire duration of that time frame. Namely, the corresponding second pulse representing the time information is typically given by a temporary variation of the amplitude of the time signal at the beginning of the respective associated time frame of the time signal. Typically, but not absolutely necessarily, no time information is present at the very end of a given time frame of the time signal.

For example, the German time signal transmitted by the German transmitter DCF-77 contains respective temporary dips or reductions of the amplitude, i.e. second pulses, having a duration of 100 msec or 200 msec directly at the beginning of a respective time frame that has a 1000 msec duration. Thus, depending on the duration of a given second pulse, the evaluating arrangement or decoder of the receiver has either 900 msec or 800 msec of time available during the time frame in order to evaluate or decode the amplitude modulated time information contained in the second pulse at the beginning of this time frame, and to still output the corresponding determined data bit during this time frame. In other words, once the second pulse has been detected and recognized as completed within the first 100 or 200 msec of the time frame, the remaining duration of the time frame is available for the receiver to carry out the evaluation and then the outputting of the corresponding data bit still during the current time frame.

According to a second alternative embodiment of the inventive method, the transmission of a respective data bit allocated to a particular time frame is transmitted or output by the receiver during a further time frame following the particular time frame to which the data bit is allocated. In this regard it is especially advantageous if the respective data bit is transmitted or output during the immediately next time frame, and especially at the beginning of the immediately next time frame that directly follows the particular time frame to which the data bit is allocated. Thus, the description that a data bit is outputted “directly after” an end of a time frame encompasses outputting that data bit at any time during the next successive time frame.

In a further advantageous embodiment, the data bit allocated to a particular time frame is transmitted or output at a reference time point that is fixedly prescribed relative to a respective time frame. Such a fixedly prescribed reference time point may, for example, refer to a second beginning of a respective time frame. Additionally or alternatively, the prescribed reference time point may refer to a rising or falling flank of the time signal. In this regard, in the example of a time signal transmitted by the German transmitter DCF-77, the falling flank of the time signal simultaneously signifies the end of a time frame as well as the second beginning of the respective following time frame.

In a very advantageous embodiment, the time points of the transmission of each respective individual data bit can be used for determining the respective second beginning of a next time frame following the corresponding time frame to which the respective data bit is allocated. This is especially advantageous in such cases in which no other method is particularly provided for determining the second beginning. Since the respective second beginning is generally necessarily recognized during the evaluation of most time signals, this can advantageously be used for the further evaluation of the time signal according to the invention without requiring great additional effort or complexity.

In a further embodiment of the inventive method, in which the decoded data bit is outputted or transmitted from the receiver to the microprocessor through a provided output terminal or pin of the receiver, this output pin is reset to a prescribed default logic signal level, for example a low logic level, after the transmission of each respective individual data bit. Thereafter, the output pin remains at the prescribed or reset logic level until the beginning of the next time frame.

Another embodiment of the inventive method involves first detecting a temporary change or variation in the transmitted time signal, which encodes or contains the corresponding time information, for determining a corresponding data bit. Next, the duration of this temporary variation of the time signal is determined, for example by counting the pulses of a reference timing pulse signal or reference clocking signal having a known constant reference frequency. Then, the respective data bit to be allocated to this time frame can be derived from the thusly determined duration of the respective temporary variation of the signal within this time frame. Namely, the duration of the temporary variation is represented by the time interval between two successive changes of the amplitude, e.g. a falling flank followed by a rising flank representing a temporary reduction of the amplitude, of the time signal. The duration of this time interval as actually measured in the time signal then leads to a conclusion of the corresponding data bit through comparison with available prescribed valid durations of the second pulses.

According to a very advantageous embodiment, before evaluating the time signal, the time signal is synchronized to the second beginning with reference to the respective minute telegram of the transmitted time signal. This is necessary for many time signals in order to be able to carry out an exact determination of the duration of a temporary variation and thus the corresponding second pulse of the time signal. For this purpose it is further advantageous to sample the received time signal in the receiver before carrying out the evaluation. Thus, the evaluation of the time signal may actually involve evaluating sampled values of the time signal, whereby the second beginning may easily be determined. The sampling produces discrete-value sampled values, which, for example, reflect the course or variation of the time signal. For this purpose, for example, a simple two-bit shift register can be provided, which indicates a flank change in the time signal, because in this case the two successive sampled values coupled into the input side of the two-bit shift register differ from one another.

Another feature of the invention involves intermediately storing the data bits produced and provided by the receiver in an external memory. In that regard, the individual data bits are intermediately stored in the external memory, advantageously in the sequence in which they are outputted by the receiver. This external memory may, for example, be a component of a microprocessor, e.g. incorporated in the microcontroller, or it may be a separately arranged discrete memory module. In that regard, the transmitted data bits may be provided to and stored in the memory either directly from the receiver or via the microprocessor. Once a number of stored data bits corresponding to a complete minute telegram of the transmitted time signal are available in the external memory, then these stored data bits are again read-out of the external memory. From this sequence of read-out data bits, the microprocessor calculates the exact clock time and/or the exact date and produces a corresponding time and/or date information signal to be provided as an input to an electronic clock. In general, the term “time information signal” can be regarded as providing clock time information and/or date information.

The time information (possible including date information) is contained bit-wise in the time signal, whereby a respective value of a respective data bit is given by a duration of a temporary variation of the amplitude of the transmitted time signal, in accordance with prescribed valid second marker durations according to the encoding protocol of the time signal transmitter. In that regard, a respective binary value is allocated to each respective data bit, whereby this binary value is derived from the actual measured duration of the respective temporary variation of the received time signal. A first duration of a temporary variation of the amplitude of the time signal represents a first logic value of the data bit, while a second duration similarly represents a second logic value of the data bit. These first and second durations are prescribed by the encoding protocol of the time signal transmitter. Typically, the first logic value refers to a logic “0” (LOW, low voltage level) and the second logic value represents a logic “1” (HIGH, high voltage level). Of course, the opposite logic value allocation could alternatively be used.

In most encoding protocols of time signals transmitted by official time signal transmitters, the above discussed temporary variation specifically involves a temporary dip or reduction of the amplitude of the time signal. Of course, the opposite variation, i.e. a binary encoding through temporary increases or peaks of the amplitude rather than temporary dips or reductions thereof, would alternatively be possible.

The time signal receiver arrangement according to the invention incorporates therein a time information acquisition arrangement or decoder for evaluating the time signal and thereby decoding the time information contained therein to acquire corresponding data bits. More particularly, the time information acquisition arrangement or decoder determines the duration of a temporary change or variation of the amplitude of the received time signal, which contains the corresponding time information. Then, the decoder derives or determines a respective data bit corresponding to the determined duration of the signal variation. For this purpose, the time information decoder advantageously comprises a bit recognition circuit, which correspondingly allocates a first logic value or a second logic value to a respective data bit based on the evaluation of the actual measured duration of the received signal variation relative to prescribed valid durations set forth in the encoding protocol of the time signal telegram.

For determining the duration, the time information acquisition arrangement or decoder comprises or is connected to a timing generator arrangement, in connection with which the actual measured duration of a temporary variation of the signal can be determined with reference to a fixed time basis. The timing generator arrangement can be embodied as or comprise a counter, especially an incrementing counter that counts the timing pulses of a reference timing pulse signal to produce a counter value signal as a measure of the duration of a respective signal variation. Alternatively or additionally, if the received time signal has been sampled before its evaluation, the counter value signal can be derived by counting the sampled values that were produced by the sampling. In this context, it is further advantageous to provide a reference timing pulse generator that produces a reference timing pulse signal with a prescribed timing pulse frequency.

It is further advantageous to provide a synchronization arrangement, which synchronizes the time signal to the second beginning with respect to the telegram of the transmitted time signal. In a further embodiment, the inventive receiver circuit arrangement further comprises a sampling arrangement for sampling the received time signal and for producing corresponding discrete-value sampled values.

In a further very advantageous embodiment of the inventive circuit arrangement, the time information acquisition arrangement or decoder is an incorporated component of a logic circuit, and especially a hard-wired logic circuit. Additionally, the synchronization arrangement and/or the counter can be respective components of this logic circuit, which may, for example, comprise an FPGA circuit or a PLD circuit. While the functions of these circuit arrangements could basically also be carried out or satisfied by the microcontroller that is typically already present in a radio-controlled clock, the preferred inventive arrangement provides the advantage that the hard-wired logic circuit can implement the inventive method in a very simple, yet very effective manner without burdening the microcontroller in this regard. Thus, the microcontroller advantageously remains available for carrying out other computational tasks.

The program controlled arrangement of the radio-controlled clock circuit arrangement is typically embodied as a microprocessor or particularly a microcontroller, such as a four-bit microcontroller. This microcontroller stores the data bits individually produced and outputted by the receiver circuit in sequence one after another in a memory arrangement specifically provided for this purpose. This memory arrangement can be an incorporated component of the program controlled arrangement, or it can be an external memory module, for example embodied as a ROM, RAM, SRAM, SDRAM, etc.

The memory space and capacity of this memory arrangement is advantageously designed or laid out in such a manner that at least the time informations, i.e. the data bits, that are necessary for representing a complete minute telegram of the received time signal can be stored simultaneously in the memory.

The radio-controlled clock circuit arrangement further includes an electronic clock that is typically connected to a reference timing pulse generator, e.g. a quartz clock oscillator that produces a reference timing pulse for timing or clocking the electronic clock on a local basis. In an advantageous further development of the invention, the reference timing pulse signal produced by the quartz clock oscillator is also used for clocking the receiver circuit and especially the time information acquisition arrangement and the counter thereof. Additionally or alternatively, the quartz clock oscillator can be used for clocking the program controlled arrangement or microcontroller of the radio-controlled clock.

### BRIEF DESCRIPTION OF THE DRAWINGS

In order that the invention may be clearly understood, it will now be described in connection with example embodiments thereof, with reference to the accompanying drawings, wherein:

FIG. 1 schematically represents the encoding scheme of a time code telegram of encoded time information transmitted by the official German time signal transmitter DCF-77, as conventionally known;

FIG. 2 is a time diagram representing a portion of an amplitude modulated time signal having five second pulses or markers, shown schematically in idealized form without interference, as transmitted by the German time signal transmitter DCF-77;

FIG. 3 is a simplified schematic block circuit diagram of a portion of a radio-controlled clock circuit for carrying out the method according to the invention;

FIGS. 4A, 4B, 4C and 4D are respective schematic signal-time diagrams respectively showing portions of the time signal as transmitted by the German transmitter DCF-77, as sampled, as demodulated, and as decoded, in connection with which the inventive method will be described in detail; and

FIG. 5 is a schematic block circuit diagram of a radio-controlled clock circuit according to the invention, showing more detail than the block circuit diagram of FIG. 3.

### DETAILED DESCRIPTION OF PREFERRED EXAMPLE EMBODIMENTS AND OF THE BEST MODE OF THE INVENTION

In all of the drawing figures, the same elements and signals, as well as the elements and signals respectively having the same functions, are identified by the same reference numbers, unless the contrary is indicated.

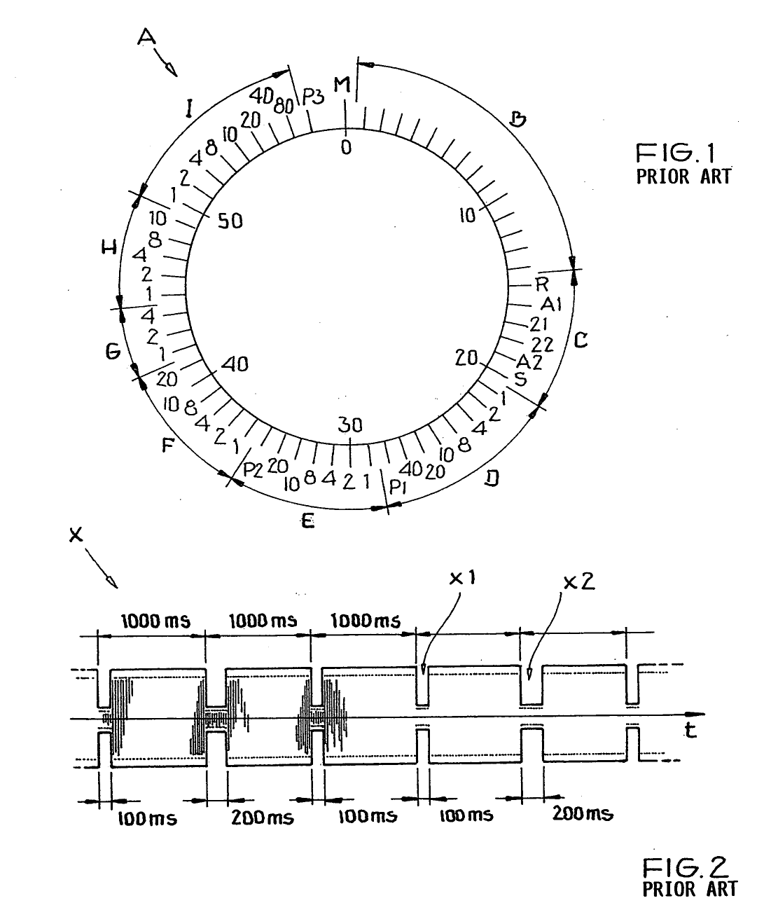

The general format of an encoding scheme or time code telegram A as conventionally known in the time signal transmitted by the German time signal transmitter DCF-77 has been explained above in connection with FIG. 1 in the Background Information section of this specification. Also, the time-variation of the amplitude-modulated time signal is schematically shown in the time diagram of FIG. 2 as discussed above.

FIG. 3 is a significantly simplified schematic block circuit diagram of a portion of a radio-controlled clock 1 for carrying out the method according to the invention. The radio-controlled clock 1 comprises a receiving antenna 2 for receiving the time signal X transmitted from a time signal transmitter which is not shown. A receiver circuit 3 is connected after or downstream from the receiving antenna 2. The receiver circuit 3 typically includes one or more filters, for example including a bandpass filter, a rectifier circuit, and a single or multi-stage amplifier circuit, respectively for filtering, rectifying and amplifying the received time signal X. The basic construction and the functional operation of such a receiver circuit 3 includes many aspects common to known receiver circuits, for example as disclosed in the above cited prior art references. For example, the filters, rectifier circuit, amplifier circuit and the like may be generally in accordance with conventional teachings.

The radio-controlled clock 1 further comprises a program controlled arrangement 5, for example a four-bit microprocessor that is connected via data line 4 to an output 3A of the receiver circuit 3. The program controlled arrangement 5 is further connected to a clocking input 3B of the receiver circuit 3 via a clocking or timing signal line 6. The program controlled arrangement 5 includes or is connected to a timing pulse generator or clocking signal generator (not shown in FIG. 3) that produces a reference clocking signal or timing pulse signal CLK that is provided via the clocking or timing line 6 to the receiver circuit 3.

In comparison to conventionally known receiver circuits, the receiver circuit 3 according to the invention is additionally equipped with a time information acquisition arrangement or decoder 7. This time information decoder 7 is embodied and adapted to evaluate and decode the time information contained in the time signal X received by the receiver circuit 3. As a result of the evaluation and decoding, the time information acquisition arrangement 7 determines the various logic values of the successive data bits corresponding to the second pulses of the successive time frames of a minute telegram of the time signal X. These data bits thus provide the necessary time information for determining the exact radio-controlled time (and/or date) in the further components of the circuit arrangement as will be described below.

Since the time information is provided in an amplitude modulated manner in the received time signal X, the data bits contained therein can only be sequentially evaluated and decoded one after another. Nonetheless, according to the invention, the data bits determined and produced by the time information acquisition arrangement or decoder 7 are not stored directly in the receiver circuit 3. Instead, the individual decoded data bits DBS (i.e. “0s ” and “1s”) are successively outputted or transmitted from the output 3A via the data line 4 to the downstream-connected program controlled arrangement 5. In this regard, as soon as an individual data bit (e.g. a “0” or a “1”) is decoded and available, it is immediately individually transmitted via the data line 4 to the program controlled arrangement 5, without first being intermediately stored.

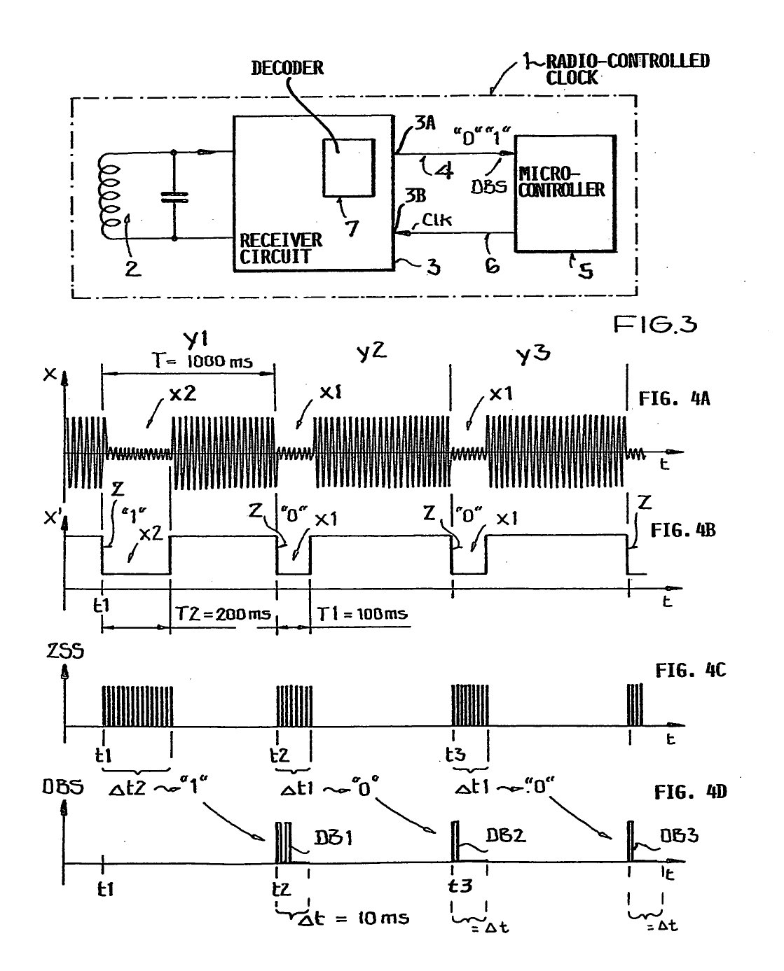

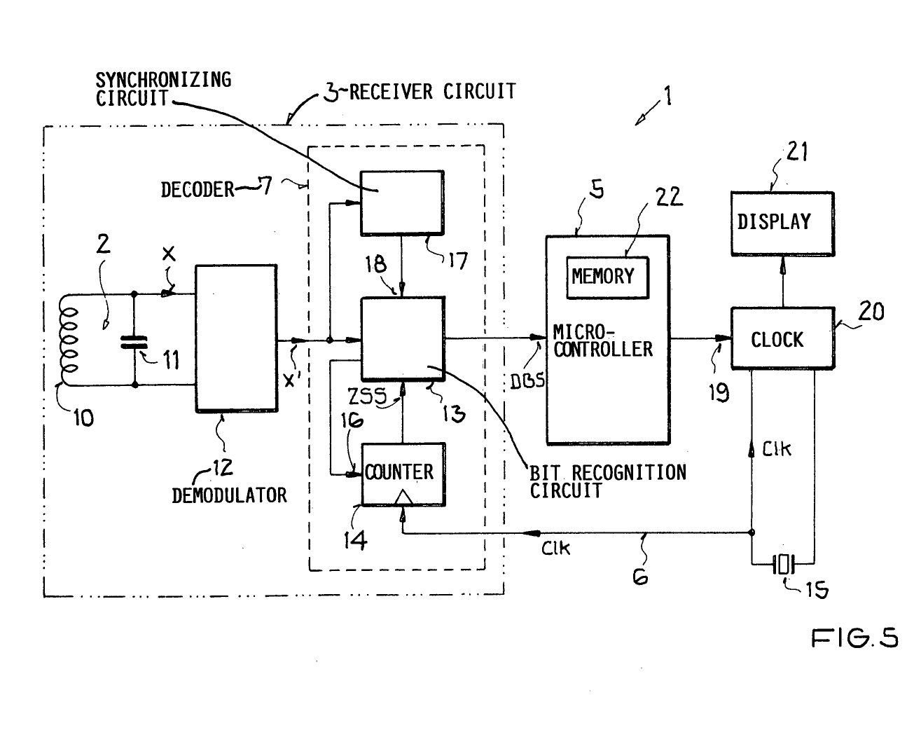

Next, the inventive method for evaluating the time information contained in the time signal X for acquiring the data bits and then transmitting these data bits from the receiver circuit 3 to the programmed controlled arrangement 5 will be described in detail in connection with the signal-time diagrams of FIGS. 4A, 4B, 4C and 4D, together making up the overall FIG. 4.

FIG. 4A shows a portion of an amplitude modulated time signal X, for example as transmitted by the official German time signal transmitter DCF-77, and as received by the receiving antenna 2. The further FIGS. 4B, 4C and 4D show the corresponding signal curves of further processing stages of the received time signal X, as will be described in detail below. It should be recognized that the several illustrations of FIG. 4 are not intended or suitable for representing a particular encoding of time information, but rather simply serve as a generic example of the principle features of such a time signal. It should also be noted that the scale along the time axis t has been greatly expanded for the sake of clarity.

The respective portions of the signals in the illustrations of FIG. 4 show three complete time frames Y1, Y2 and Y3 of the time signal X. The duration of each time frame Y1, Y2 or Y3 amounts to exactly T=1000 msec. The time signal x transmitted by the German transmitter DCF-77 contains two different second pulses X1 and X2 represented by temporary dips or reductions of the signal amplitude for the binary encoding of the time information. Particularly, the signal includes first temporary reductions X1 having the duration T1=100 msec, and second temporary reductions X2 having the duration of T2=200 msec. These durations T1 and T2 represent the ideal or nominal durations of valid second pulses prescribed by the encoding protocol of the German time signal transmitter DCF-77. In this regard, the first reductions X1 correspond to the binary “0” while the second reductions X2 correspond to the binary “1”. The binary “1” and the binary “0” represent the possible logic values of respective data bits.

As mentioned above, FIG. 4A shows the raw amplitude modulated time signal X as it is received by the receiving antenna 2. Next, FIG. 4B illustrates the demodulated time signal X′ that has been derived by demodulating the amplitude modulated time signal X. This demodulation is achieved by a demodulator incorporated in the receiver circuit 3, as will be described in detail below in connection with FIG. 5.

Next, the receiver circuit 3 decodes the time information contained in the demodulated time signal X′, by determining and allocating a respective corresponding data bit or control bit to each temporary reduction X1 and X2 of the demodulated time signal X′. Immediately or directly after the respective decoding thereof, these data bits are then transferred to the downstream-connected microprocessor 5.

More particularly, the decoding of each individual data bit involves first determining the respective actual duration Δt1 or Δt2 of the respective associated temporary dip or reduction X1 or X2 of the signal. In this regard, the actual duration Δt1 or Δt2 can be very easily determined by counting the timing pulses of a reference clocking signal or timing pulse signal CLK occurring between the detected beginning and the detected end of the respective amplitude reduction X1 or X2. For example, the reference clocking signal CLK is provided as a succession of pulses having a reference frequency (for example 1024 Hz) produced by subdividing or dividing-down a pulse frequency provided by a quartz clock oscillator (for example 32.768 kHz). Thus, typically the counter counts up, i.e. increments, each successive pulse of the reference clocking signal CLK beginning at the detected start or beginning of the temporary amplitude reduction X1 or X2, for example the second beginning Z of the demodulated time signal X′.

FIG. 4C shows the successive pulses that are counted, and thus represents the counter value signal ZSS of the counter. This counter value signal is a measure of the actual duration Δt1 or Δt2 of a temporary reduction X1 or X2 of the demodulated time signal X′. At the detected end of the temporary dip or reduction X1 or X2, i.e. at the next rising flank of the demodulated time signal X′, the counter stops incrementing or counting up the pulses. Thus, from the accumulated counter value of the counter determined in this manner, up to the time point of the end of the respective temporary amplitude reduction, and using the known exact reference frequency of the reference clocking signal CLK, it is possible to exactly determine the exact duration Δt1 or Δt2 of the respective amplitude reduction X1 or X2.

Next, the determined durations Δt1 or Δt2 are correspondingly assigned to logic values of data bits DB1 or DB2 allocated thereto, as shown in FIG. 4D, by comparing and matching the actual measured durations Δt1 or Δt2 to the respective prescribed ideal durations T1 or T2 (e.g. within an acceptable tolerance range) and the corresponding logic values allocated thereto.

Referring to FIG. 4D, the information transmission of the encoded data bits DB1 and DB2 respectively begins at a fixedly prescribed reference time point, for example at the second beginning t2, t3 of the respective next subsequent time frame Y2, Y3, in the present example embodiment of the inventive method. At the end of a respective data transmission, which is characterized by a defined, fixedly prescribed number of bits DB1, DB2 of the data bit signal DBS, the data bit signal DBS is again reset to a low logic signal level. Thereafter, the data bit signal DBS will remain at this low logic signal level until the beginning of the next subsequent time frame.

For the transmission of a respective data bit “0”, “1”, a defined fixedly prescribed number of bits DB1, DB2 is necessary. This fixedly prescribed number of bits DB1, DB2, for example, characterizes the respective logic value of the respective data bit “0”, “1”. In addition to the value of the data bit allocated to a respective amplitude reduction X1, X2, it is further possible to transmit the exact measured duration Δt1, Δt2 of the amplitude reduction X1, X2. Depending on what informations are to be transmitted together to the program controlled arrangement 5, the encoded data bit signal DBS allocated to a respective amplitude reduction X1, X2 comprises a different encoding and bit width or duration of the bits.

The following discussion will describe two different embodiments or variations of methods for transmission of the data bits.

First Method

In most time signal encoding protocols, the time information contained in the received time signal X is given on the one hand by the presence of amplitude reductions or dips X1, X2 and on the other hand by the respective particular durations of these amplitude reductions X1, X2. Thus, in the protocol of the German time signal transmitted by the transmitter DCF-77, an amplitude reduction X1 having a duration of 100 msec corresponds to a logic “0”, while an amplitude reduction X2 having a duration of 200 msec corresponds to a logic “1”. In addition to these data bits, the signal X further includes a control bit S (also known as a start bit), which is represented by the lack of an amplitude reduction within the respective time frame. This control bit or start bit S signifies the beginning of the minute in the telegram of the time signal X.

The actual measured duration Δt1, Δt2 of the respective amplitude reductions X1, X2 can be allocated to respective data bit logic values through a table look-up of corresponding values in a look-up table. In this manner it is possible to exactly define the received second pulse with a total of two bits plus the start bit 2. For example, possible allocations could be selected as follows:
start bit S: 10;
data bit 0: 00;
data bit 1: 01.

In the ideal case, the actual measured duration Δt1 will correspond to the prescribed first duration T1, and the actual measured duration Δt2 will correspond to the prescribed second duration T2. Typically, however, the received time signal X has an interference signal superimposed more or less strongly thereon, which leads to some deviation of the received, detected and measured durations Δt1, Δt2 of the detected amplitude reductions X1, X2 from the prescribed ideal durations T1, T2. For example, assume that the first amplitude reduction X1 as actually detected has a measured duration Δt1 of 75 msec, and the second detected amplitude reduction X2 has an actual measured duration Δt2 of 180 msec. The evaluation process allows a certain defined range of deviation from the ideal, while still properly recognizing the “intended” duration and thus the “intended” bit value of each respective amplitude reduction X1, X2. Thus, even the actually received amplitude reductions X1, X2 having measured durations Δt1, Δt2 deviating from the ideal durations T1, T2 (within a defined acceptable range) will have the corresponding data bits allocated thereto, for example through the use of a stored table as mentioned above. The data bits “0”, “1” produced in this manner are transformed into a data bit signal DBS as shown in FIG. 4D, which is then transmitted to the program controlled arrangement or microprocessor 5 in a manner clocked by the reference clocking signal CLK. The transmission of each individual transmitted data bit DB1, DB2, DB3 in that regard is carried out in encoded form.

In the present example in which the actual measured duration of the amplitude reduction X2 amounts to Δt2=180 msec, this amplitude reduction X2 will have a received bit value “1” allocated thereto according to the DCF-77 encoding protocol. Thus, considering this received bit value “1”, together with the start bit “1” at the beginning and the end bit “0” at the end, the data bit signal DBS transmitted from the receiver circuit 3 to the program controlled arrangement 5 has the bit sequence “1 01 0”. The end bit “0” is always provided at the end of the transmission, and the signal remains at this level or value until the beginning Z of the next time frame. On the other hand, in the case of the amplitude reduction X1 having the actual measured duration Δt1=70 msec, a “0” is allocated to this amplitude reduction X1, so that the corresponding data bit signal DBS will comprise the logic value sequence “1 00 0”.

Second Method

The measured duration Δt1, Δt2 of a respective amplitude reduction X1, X2 is determined and outputted in a binary manner as a whole number multiple of the duration of the period of the reference clocking signal CLK. In the present example, the reference clocking signal CLK has a reference frequency of f=1024 Hz, which corresponds to a period duration of 977 μsec. As mentioned above, in this example, the actual measured duration of the second amplitude reduction X2 amount to Δt2=180 msec, which corresponds approximately to 184 reference pulses. In order to be able to represent all possible time durations between 0 and 1023 reference pulses, it is necessary to provide a total of ten bits for the encoding. The most significant bit (MSB) corresponds to 512 pulses, i.e. the duration Δt=500 msec, while the least significant bit (LSB) corresponds to a single pulse, i.e. Δt=(approx.) 1 msec.

For an amplitude reduction X2 having an actual measured duration Δt2=180 msec, the data bit signal DBS transmitted from the receiver circuit 3 to the program controlled arrangement 5 thus has the sequence “1 0010111000 0”.The first or so-called most significant bit MSB “1” in that regard represents the start bit Ho, which is followed by the ten data bits providing the binary representation of the counter value defining the measured duration of Δt2=180 msec., and then the end bit “0”. Thus, the data bits begin with two data bits (in the highest and second-highest significance positions) at the low logic level “0” The first data bit with a high logic level “1” (at the third-highest significance position) corresponds to 126 pulses of the reference clocking signal. Similarly, it is apparent that the following sequence “0111000” has “1” bits at the binary positions representing 32+16+8 counting pulses. Thus the total of the data bits represents 184 counting pulses, which corresponds to a duration of 184×0.977 msec=Δt2=180 msec. The last or so-called least significant bit (LSB) “0” is provided at the end of the transmission as mentioned above, and the signal remains at this value until the beginning Z of the next time frame.

With the transmission of a total of 10 data bits and 1 start bit S for characterizing the duration Δt1, Δt2, and therewith the value of an amplitude reduction X1, X2, the transmission of this encoded data bit signal DBS of these data bits DB1, DB2 would be completed after less than 10 msec with a clocking pulse frequency of 1024 Hz. Thus, during the remaining 990 msec of the 1000 msec duration of a respective time frame Y1, Y2, Y3, no further encoded data bits DB1, DB2 are transmitted. For this reason, the microcontroller 5 is only burdened or busy receiving the data bits DB1, DB2 for much less than 10% (e.g. about 1%) of the time, and thus remains free for carrying out other tasks for much more than 90% (e.g. about 99%) of the time, because the beginning Z of the next subsequent time frame Y1, Y2, Y3 is well known, so that the microcontroller can switch its attention back to receiving the data bits at the appropriate time. In this manner, the computational resources of the microcontroller 5 can advantageously be utilized for other tasks.

In the presently described second method, the actual measured duration Δt1, Δt2 of an amplitude reduction X1, X2 is determined with an accuracy of (about) 1 msec. Since the durations Δt1, Δt2 of the various amplitude reductions X1, X2 in the various time signal encoding protocols are typically defined in 100 msec steps, such a high accuracy of the determination of the duration of an amplitude reduction is typically not necessary. For this reason, it is generally possible to advantageously omit a few of the last bits, i.e. least significant bits, for example the three or four least significant bits.

In the first method described above, more or less only the value of a data bit was transmitted, while in the second method not only the value of the data bit, but also the actual measured duration Δt1, Δt2 of the amplitude reduction X1, X2 on which this data bit is based are transmitted together. From these additional informations regarding the duration, conclusions can be drawn, to some extent, as to the received signal quality. The above described first and second methods may, of course, be combined with one another. It should also be understood, of course, that other methods for producing and transmitting the data bits can be used in addition to or instead of the above described first and second methods.

FIG. 5 schematically shows a block circuit diagram with more detail of a radio-controlled clock 1 according to the invention. This clock 1 comprises one or more receiving antennas 2 for receiving the time signal X transmitted by a time signal transmitter (not shown). In the present example embodiment, the antenna 2 is embodied as a coil 10 with a ferrite core, to which a capacitive element 11, for example a capacitor 11, is connected in parallel. The radio-controlled clock 1 further comprises a receiver circuit 3 as generally described above. This receiver circuit 3 comprises a demodulator circuit 12 of which the input side is connected to the receiving antenna 2. The demodulator circuit 12 receives the time signal X, demodulates it, and correspondingly produces the demodulated time signal X′, which is provided from the output of the demodulator circuit 12 to the time information acquisition arrangement or decoder 7, which acquires or extracts the time information contained in the demodulated time signal X′.

For this purpose, the time information acquisition arrangement or decoder 7 comprises a bit recognition circuit 13, which is adapted to allocate a first or second logic value “0”, “1” respectively to each data bit in conformance with the encoding protocol for the particular time telegram of the received time signal, based on the durations Δt1 and Δt2 of the amplitude variations X1, X2 in comparison to the prescribed ideal durations T1, T2 as discussed above. In this regard, first the actual durations Δt1, Δt2 of the respective amplitude variations X1, X2 must be determined. For this purpose, the time information acquisition arrangement or decoder 7 further comprises a counter 14, which is clocked by the reference clocking signal CLK provided by a reference clock signal or timing pulse generator 15 via the clocking or timing line 6 in the present example embodiment. The reference timing pulse generator may advantageously comprise a quartz clock oscillator 15.

The counter 14 may be embodied as an incrementing counter or alternatively as a decrementing counter. In any event, the counter 14 begins counting from 0 (or some other default value) and continuously counts the successive pulses of the reference clocking signal or timing pulse signal CLK upward or downward. The present existing counter value of the counter 14 is provided and can be tapped at the output side of the counter 14 as a corresponding counter value signal ZSS. The counter value signal ZSS is a measure for the present actual duration of the respective pertinent amplitude variation X1, X2. The corresponding counter value signal ZSS is provided to the bit recognition circuit 13, which evaluates the respective present existing counter value and thus the corresponding time duration since the beginning of a respective amplitude variation X1, X2. At the detected end of an amplitude variation X1, X2, or respectively at a new second beginning, the counter 14 is reset back to 0 by a control signal 16 produced by the bit recognition circuit 13.

As mentioned above, the number of pulses of the reference clocking signal CLK counted by the counter 14 produces the resulting accumulated counter value signal ZSS that corresponds to the actual duration Δt1, Δt2 of a respective amplitude variation X1, X2. Based on this information, the bit recognition circuit 13 now draws a conclusion regarding, i.e. determines, the respective corresponding logic value of the data bit, either a “0” or a “1” represented by the respective present duration by comparing the actual duration to the prescribed ideal or nominal durations to which the bit values are respectively assigned. Thereby, the bit recognition circuit 13 decodes the time information in the time signal X′. Thus, in the present example embodiment, the time information acquisition arrangement or decoder 7 incorporated in the receiver circuit 3 carries out the function of a decoding arrangement that has previously and conventionally been embodied in a microcontroller 5 of the radio-controlled clock.

Next as a result, the bit recognition circuit 13 produces a data bit signal DBS dependent on the respective decoded data bit “0” or “1”, and this data bit signal DBS is transmitted immediately to the downstream-connected program controlled arrangement 5. The individual data bits are intermediately or temporarily stored in a memory 22 within the program controlled arrangement 5.

Advantageously, the time information acquisition arrangement or decoder 7 further comprises a synchronizing arrangement 17, which recognizes an amplitude change in the demodulated time signal X′ and thereby detects or recognizes a respective second beginning. In the case of recognizing a second beginning, the synchronizing arrangement 17 produces a control signal 18 that is provided to the bit recognition circuit 13, for the purpose of synchronizing the bit recognition circuit 13 or even the entire time information acquisition arrangement or decoder 7 to the second beginning with respect to the telegram of the transmitted time signal X.

Typically, a microcontroller is provided as the program controlled arrangement 5. In the case of a typical radio-controlled clock 1, the microcontroller 5 is embodied as a four-bit controller. This microcontroller 5 is embodied and adapted to receive the data bit signal DBS produced by the receiver circuit 3 or particularly the bit recognition circuit 13, and to calculate therefrom an exact clock time and/or an exact date. Moreover, the microcontroller 5, from this calculated clock time and/or date, produces a time information signal 19 representing the clock time and/or date.

The radio-controlled clock 1 further comprises an electronic clock 20, of which the clock time is locally controlled based on the quartz clock oscillator 15. The electronic clock 20 is connected to an indicator, for example a display 21, by means of which the clock time and/or date can be indicated, i.e. displayed. The clock 20 further receives the time information signal 19, based on which the clock 20 adjusts or corrects the local clock time and/or date displayed on the display 21.

Any one or more of the receiver circuit 3, the demodulator circuit 12, and the time information acquisition arrangement or decoder 7 can be respective incorporated components of a logic circuit, and especially a hard-wired logic circuit. Through the use of such a logic circuit, the microcontroller 5 can be unburdened from the tasks involved in the evaluation and decoding of the received time signal, so that the microcontroller 5 remains available for performing other tasks.

Although the invention has been described and illustrated above in connection with preferred example embodiments thereof, the invention is not limited to these disclosed embodiments, but rather is modifiable to cover a great variety and number of different embodiments. For example, the invention is not limited to the particular numerical values or ranges disclosed herein as examples. To the contrary, the scope of the invention also covers variations or changes of numerical values and ranges as would be understood by a person of ordinary skill in the art upon considering the present disclosure.

In the above described example embodiments, the time encoding was realized by temporary dips or reductions of the signal amplitude of the carrier signal at the respective beginning of respective time frames. It should be understood that the encoding could alternatively be realized by temporary increases or any other variation of the signal amplitude of the carrier signal in the respective time frames. Also, other types of signal modulation could alternatively be used.

While the above discussion has especially related to a radio-controlled clock receiving the time signal via a wireless radio transmission through an antenna, the present invention also relates to a method and clock apparatus receiving a time signal via a hard-wired transmission. For example, systems including several clocks that are to be synchronized with one another and that are connected to each other by a time signal wire for this purpose, can also be embodied according to the present invention, and are covered within the scope of the appended claims. Such clocks may generally be regarded as remote-controlled clocks, but are also to be understood within the term radio-controlled clocks.

The illustrated and explained example embodiment of a receiver circuit is merely one possible example of a concrete circuit for embodying an inventive receiver circuit and radio-controlled clock. This example embodiment can readily be varied by exchanging individual or simple circuit components or entire functional blocks or units, as would be understood by a person of ordinary skill in the art upon considering this disclosure.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A method of processing a transmitted time signal, comprising the steps:
a) receiving, with a receiver, an amplitude-modulated time signal that has been transmitted from a time signal transmitter, wherein said time signal comprises a succession of time frames and encodes time information bit-wise in successive data bits, with at least a respective one of said data bits allocated to each respective one of said time frames;
b) in said receiver, evaluating said time signal or a related signal derived therefrom to acquire said time information for a respective selected time frame among said time frames;
c) in said receiver, based on said evaluating, producing a respective individual data bit dependent on said time information and allocated to said selected time frame; and
d) outputting, from an output of said receiver, said individual data bit allocated to said selected time frame, during or at an end of or directly after said end of said selected time frame of said time signal being received in said step a).

2. The method according to claim 1, wherein said individual data bit is not stored for longer than a duration of one of said time frames in said receiver.

3. The method according to claim 1, wherein said evaluating of said time signal to acquire said time information for said selected time frame is carried out during said receiving of said selected time frame.

4. The method according to claim 1, wherein respective pluralities of said time frames are organized into respective telegrams each having a duration of one minute, and wherein said evaluating of said time signal to acquire said time information for said selected time frame is carried out during and before completion of said receiving of a respective one of said telegrams that includes said selected time frame.

5. The method according to claim 1, further comprising repeating said steps b), c) and d) individually and successively for successive ones of said individual data bits in connection with successive ones of said time frames.

6. The method according to claim 5, further comprising, after said step d), processing said individual data bits in a microprocessor separate from said receiver to determine therefrom at least one of a clock time and a date.

7. The method according to claim 1, wherein said outputting of said individual data bit is carried out during said selected time frame of said time signal being received.

8. The method according to claim 1, wherein said outputting of said individual data bit is carried but at said end of said selected time frame of said time signal being received.

9. The method according to claim 1, wherein said outputting of said individual data bit is carried out during a next time frame that directly follows said selected time frame among said time frames of said time signal being received.

10. The method according to claim 1, wherein said outputting of said individual data bit is carried out at a pre-specified fixed reference time point with respect to one of said time frames.

11. The method according to claim 10, wherein said reference time point is defined as at least one of a determined beginning of a second, a rising flank, and a falling flank of said one of said time frames of said time signal being received.

12. The method according to claim 1, further comprising determining a beginning of a second of a next time frame that directly follows said selected time frame among said time frames of said signal being received, wherein said determining of said beginning is carried out with reference to a time point at which said outputting of said individual data bit allocated to said selected time frame takes place.

13. The method according to claim 1, further comprising resetting an output level of said output to a pre-specified default logic level after said outputting of said individual data bit from said output.

14. The method according to claim 1, wherein said steps b) and c) comprise the following processes:
detecting a temporary variation of an amplitude of said time signal in said selected time frame;
determining an actual duration of said temporary variation; and
determining a respective logic value of said individual data bit dependent on said actual duration.

15. The method according to claim 14, wherein said determining of said respective logic value comprises comparing and matching said actual duration to one of prescribed ideal durations of valid amplitude variations to which respective logic values are allocated.

16. The method according to claim 15, wherein a first one of said logic values is allocated to a first one of said ideal durations and a second one of said logic values is allocated to a second one of said ideal durations.

17. The method according to claim 16, wherein said first logic value is a logic zero and said second logic value is a logic one.

18. The method according to claim 14, wherein said temporary variation is a temporary reduction of said amplitude of said time signal.

19. The method according to claim 14, wherein said detecting of said temporary variation comprises detecting two successive opposite flank changes of said time signal being received, and said determining of said actual duration comprises measuring a duration of a time interval defined between said two successive opposite flank changes.

20. The method according to claim 14, wherein said determining of said actual duration comprises counting timing pulses of a reference timing pulse signal having a prescribed reference frequency during said temporary variation.

21. The method according to claim 1, further comprising, before said step b), an additional step of synchronizing said time signal to a beginning of a second of one of said time frames.

22. The method according to claim 1, further comprising, before said step b), sampling said time signal as received to prepare a sampled time signal as said related signal.

23. The method according to claim 1, further comprising, after said step d), the following additional steps:
e) intermediately storing a succession of said individual data bits, in a sequence as outputted from said receiver, in a memory external to said receiver;
f) when a number of said individual data bits corresponding to a complete minute-long telegram of successive ones of said time frames of said time signal is stored in said memory, then reading-out said individual data bits from said memory; and
g) determining and producing a time and/or date information signal from and dependent on said data bits read-out from said memory.

24. The method according to claim 23, wherein said step g) is carried out in and by a microprocessor external to said receiver.

25. A circuit arrangement for receiving and acquiring time information from a time signal that is transmitted by a time signal transmitter and that has said time information encoded in successive data bits in successive time frames therein, said circuit arrangement comprising:
a receiving antenna adapted to receive said time signal; and
a receiver circuit connected to said receiving antenna and adapted to process said time signal;
wherein said receiver circuit comprises:
a time information acquisition arrangement adapted to process said time signal so as to acquire said time information therefrom; and
a bit output arrangement that is included in or separate from said time information acquisition arrangement, and that is adapted to decode and produce a respective individual data bit corresponding to said time information and allocated to a selected time frame among said time frames, and that is adapted to output said respective individual data bit from an output of said receiver circuit during, at an end of, or directly after said end of said selected time frame.

26. The circuit arrangement according to claim 25, wherein said time information acquisition arrangement is arranged and adapted to detect a temporary variation of an amplitude of said time signal, to determine an actual duration of said temporary variation, and to derive said individual data bit from said actual duration.

27. The circuit arrangement according to claim 26, wherein said bit output arrangement comprises a bit recognition circuit adapted to allocate a first logic value or a second logic value to said individual data bit by comparing said actual duration to first and second ideal durations prescribed by an encoding protocol of said time signal and respectively allocated to said first and second logic values.

28. The circuit arrangement according to claim 26, wherein said receiver circuit further comprises, included in or separate from said time information acquisition arrangement, a counter that is adapted to determine said actual duration by at least one of counting timing pulses of a reference timing pulse signal and counting sampled values obtained by sampling said time signal, to thereby provide a counter value of said counter as a measure of said actual duration.

29. The circuit arrangement according to claim 28, further comprising, included in or separate from said receiver circuit, a reference timing pulse generator adapted to provide said reference timing pulse signal having a prescribed frequency.

30. The circuit arrangement according to claim 25, wherein said receiver circuit further comprises a synchronizing arrangement adapted to synchronize said time signal to a beginning of a second of one of said time frames with respect to a telegram consisting of a plurality of said time frames of said time signal.

31. The circuit arrangement according to claim 25, wherein said receiver circuit further comprises a sampling arrangement adapted to sample said time signal and produce corresponding sampled values.

32. The circuit arrangement according to claim 25, wherein said time information acquisition arrangement is incorporated in a hard-wired logic circuit.

33. A radio-controlled clock including said circuit arrangement according to claim 25 and further comprising:
a memory that is separate from said receiver circuit, connected to said output of said receiver circuit, and adapted to sequentially store said individual data bits,
a program-controlled arrangement that is separate from said receiver circuit, may include or not include said memory, and is adapted to read-out said individual data bits from said memory and produce a time information signal in response to and dependent on said data bits; and
a local electronic clock connected to said program-controlled arrangement to receive said time information signal and adapted to indicate a time and/or a date in response to and dependent on said time information signal.

34. The radio-controlled clock according to claim 33, wherein said program-controlled arrangement comprises a microprocessor or a microcontroller.

35. The radio-controlled clock according to claim 33, wherein said memory has a sufficient storage capacity and suitable arrangement so that said memory is adapted to store a number of said individual data bits corresponding to a complete minute-long telegram of said time frames of said time signal.

36. The radio-controlled clock according to claim 33, further comprising a reference timing pulse signal generator that is connected to said local electronic clock and to said receiver circuit, and that is adapted to provide a reference timing pulse signal having a defined frequency to said local electronic clock and to said receiver circuit.
